(19) United States
(12) Patent Application Publication
(10) Pub. No.: US 2026/0094237 A1
(43) Pub. Date: Apr. 2, 2026

(54) ARTIFACT-REDUCING IMAGE DEMOSAIC CIRCUITS

(71) Applicant: NVIDIA Corporation, Santa Clara, CA (US)

(72) Inventor: Erwin Liu, San Carlos, CA (US)

(21) Appl. No.: 18/903,339

(22) Filed: Oct. 1, 2024

(51) Int. Cl. G06T 3/4015; G06T 5/20; G06T 7/90; G06V 10/56; G06V 10/60; H04N 1/60

(52) U.S. Cl. CPC G06T 3/4015; G06T 5/20; G06T 7/90; G06V 10/56; G06V 10/60; H04N 1/6002; G06T 2207/10024

(57) ABSTRACT

Disclosed are systems and circuits for image demosaicing with minimal artifacts. The circuits are to compute a color value within a first color space for a first pixel of a plurality of pixels based at least on color value within the first color space of a first group of neighboring pixels of the first pixel and compute a first chrominance value within a second color space for the first pixel based at least on the computed color value within the first color space. The circuits are also to compute a luminance value within the second color space for the first pixel based at least on the first chrominance value within the second color space and convert the luminance value within the second color space and the first chrominance value within the second color space to an output pixel value within a third color space.

### TECHNICAL FIELD

At least one embodiment pertains to circuits for demosaicing color samples to reconstruct a full color image with minimal artifacts.

### BACKGROUND

Demosaicing is a digital image process used to reconstruct a full-color image from the incomplete color samples output from an image sensor overlaid with a color filter array (CFA), such as a Bayer filter. Common in digital cameras and other imaging devices, a CFA allows a single sensor to capture color information by filtering the light striking each pixel according to a specific color (e.g., red, green, or blue). Due to this process, each pixel only captures one of the three primary colors, necessitating the demosaicing process to interpolate the missing colors for each pixel. The objective of demosaicing is to reconstruct a high-quality full-color image by estimating the colors that were not captured at each pixel, using various algorithms to infer the missing information based on the color information of neighboring pixels.

### BRIEF DESCRIPTION OF THE DRAWINGS

FIG. 1 is a block diagram of an example system for performing image demosaicing with minimal artifacts, according to at least one embodiment;

FIG. 2 is a block diagram of an example data flow for demosaicing color samples to obtain a full-color output, according to at least one embodiment;

FIG. 3A is a block diagram of an example kernel of a poly-phase filter, according to at least one embodiment;

FIG. 3B is a block diagram of an example kernel of a poly-phase filter, according to at least one embodiment;

FIG. 3C is a block diagram of an example kernel of a poly-phase filter, according to at least one embodiment;

FIG. 3D is a block diagram of an example kernel of a poly-phase filter, according to at least one embodiment;

FIG. 4 is a block diagram of an example data flow for luma directional enhancement, according to at least one embodiment;

FIG. 5 is a flow diagram of an example method for image demosaicing with minimal artifacts, according to at least one embodiment; and

FIG. 6 is a block diagram illustrating an exemplary computer system, in accordance with at least one embodiment of the present disclosure.

### DETAILED DESCRIPTION

Demosaicing an image, while essential for creating full-color digital images from raw sensor data, can introduce several side effects. The process may introduce various types of artifacts, such as moiré patterns, false colors, and/or zippering effects around edges where the color contrast is high. Interpolation during demosaicing can sometimes lead to the blurring of fine details, especially in areas with subtle textures or high-frequency details. Additionally, achieving accurate color reproduction can be a challenge, and demosaicing can sometimes result in color shifts where the colors in the final image do not exactly match the original scene.

The present disclosure provides for systems and techniques that allow for demosaicing color samples to reconstruct a full-color image with minimal artifacts. Color samples (e.g., a color filter array (CFA)) can be demosaiced to reconstruct a full-color image corresponding to the color samples. The color samples can be in a first (e.g., input) color space (e.g., RGB) and can be converted into a second (e.g., output) color space (e.g., YUV). In some embodiments, the color samples are converted to an intermediate color space (e.g., YiUiVi) before being converted to the second (e.g., output) color space. In the first color space, each pixel can have a single value and may not have a value for each component of the color space. For example, a first pixel may have only an R value without having a G value or a B value. A second pixel may have only a G value without having a R value or a B value, and so on. In the second color space, each pixel can have a value for each component of the output color space. For example, each pixel can have a luminance (luma) (e.g., Y) value, a blue chrominance (chroma) (e.g., U, Cb) value, and a red chrominance (chroma) (e.g., V, Cr) value. The values of the first color space can be converted to the values of the second color space using chroma-guided interpolation and luma estimation. In some embodiments, chroma-guided interpolation includes chroma filtering and/or chroma filtering with trimming. In some embodiments, additional processing is performed during the demosaic process, such as a luma zipper filter (LZF) and/or luma directional enhancement (LDE).

During chroma-guided interpolation, the pixel values of the color samples of the first color space (e.g., RGB values) can be converted to values in an intermediate color space (e.g., YiUiVi values). The color samples can include a CFA with one or more pixels. Each pixel can have a single value corresponding to one component of the first color space. In some embodiments, the CFA is obtained using an RGGB Bayer filter. In such a case, because there are more G values than R or B values, up-sampling filters and/or interpolation can be performed to determine a G value for each pixel of the CFA. Based on the G values, values within the intermediate color space can be computed. For example, first chroma values (e.g., Ui values) can be computed at pixels of the CFA that have a B value, and second chroma values (e.g., Vi values) can be computed at pixels of the CFA that have an R value. Up-sampling and/or interpolation can be performed again to determine intermediate chroma values (e.g., Ui values and Vi values) for each pixel of the CFA. In some embodiments, the intermediate chroma values Ui and Vi can be smoothed using a low-pass filter to obtain smoothed intermediate chroma values Uc and Vc.

In some embodiments, the intermediate luma values (e.g., Yi values) can be calculated using the following:

Yi=0.25*R+0.5*G+0.25*B.

In some embodiments, the intermediate chroma values (e.g., Ui values and Vi values) can be calculated using the following formulas:

Ui=0*R−0.5*G+0.5*B

and

Vi=0.5*R−0.5*G+0*B.

During luma estimation, intermediate luma values (e.g., Yi values) corresponding to the luminance component of the intermediate color space (e.g., YiUiVi format) can be computed for each pixel of the CFA based on the intermediate chroma values (e.g., Ui values and Vi values) computed during chroma-guided interpolation and the color samples of each pixel. For example, the color sample value of a particular pixel can be combined with the computed Ui value and Vi value for that pixel to obtain the Yi value for the pixel. In some embodiments, different weights are applied to the Ui and Vi values (e.g., chroma correction) based on the color of the pixel in the CFA. For example, the Yi value for an R pixel can be computed using the following

Yi=R+0.5Ui−1.5Vi.

The Yi value for a G pixel can be computed using the following

Yi=G+0.5Ui+0.5Vi.

The Yi value for a B pixel can be computed using the following:

Yi=B−1.5Ui+0.5Vi.

In some embodiments, the smoothed values (e.g., Uc, Vc) are used instead of the intermediate values (e.g., Ui, Vi) to obtain a luma estimate (e.g., Yc).

In some embodiments, a luma zipper filter can be applied to the intermediate luma values (e.g., Yi values, Yc values) to remove (or reduce) zippering artifacts that would appear in the full-color image. The luma zipper filter can be a bilateral low pass filter. In some embodiments, the luma zipper filter is a 2-dimensional filter such that the output is a linear combination of a window of input intermediate luma values weighted by fixed filter kernel coefficients and dynamic range kernel coefficients that depend on the input range and the input intermediate luma values. The fixed filter kernel can have a wide passband to preserve high frequency content (e.g., textures, image details, etc.) in the full-color image. In some embodiments, the improved value of a single intermediate luma value can be computed based on a 9×9 patch of input intermediate luma values.

In some embodiments, a directional filter can be applied to the intermediate luma values (e.g., Yi values, Yc values) to smooth edges in the final full-color image. The directional filter can start with a 9×9 patch of raw values (e.g., from the CFA), apply a bilinear LPF to compute a 7×7 patch of smoothed luma values, detect edge directions within a 5×5 patch of the smoothed luma values, and then can modify the intermediate luma value centered within the 5×5 patch based on the detected direction.

The resulting intermediate values (e.g., YiUiVi, YcUcVc) can be converted to the output color space (e.g., YUV) using one or more transformation operations. For example, the intermediate values can be multiplied by one or more transformation matrices to obtain the output values.

The advantages of the disclosed techniques include but are not limited to improved image quality and reduced visual artifacts after converting raw CFA color samples to a full-color image.

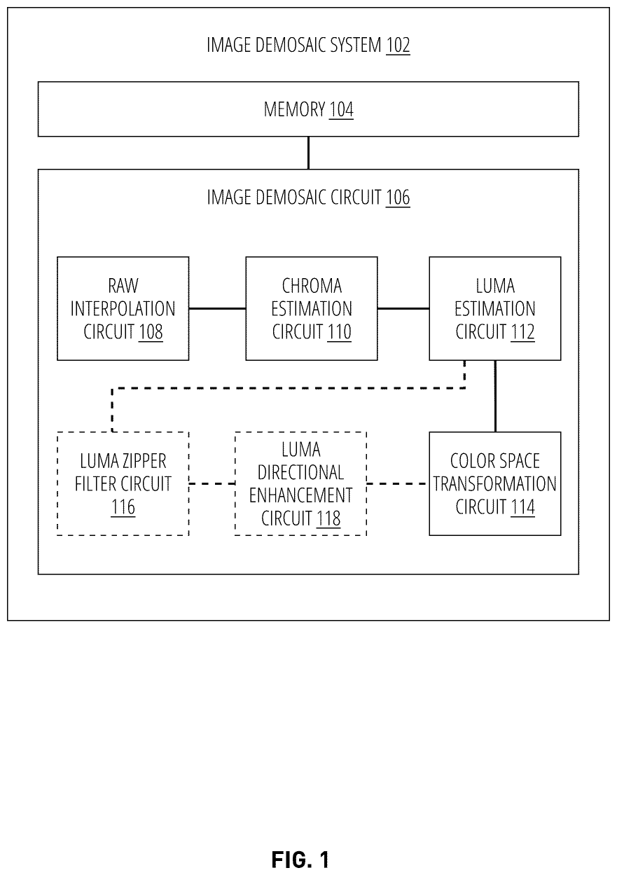

FIG. 1 is a block diagram of an example image demosaic system 102 for performing image demosaicing with minimal artifacts, according to at least one embodiment. In some embodiments, image demosaic system 102 can be included as part of a system on a chip (SOC). In some embodiments, image demosaic circuit 106 can be included as part of a SOC. In some embodiments, image demosaic system 102, image demosaic circuit 106, and/or one or more circuits of image demosaic circuit 106 (e.g., raw interpolation circuit 108, chroma estimation circuit 110, luma estimation circuit 112, color space transformation circuit 114, luma zipper filter circuit 116, luma directional enhancement circuit 118) can be included as part of an image processing pipeline.

Image demosaic system 102 can include memory 104 and image demosaic circuit 106. Memory 104 can include one or more registers, one or more caches (e.g., L1 cache, L2 cache, etc.), and/or main memory (e.g., random-access memory (RAM), dynamic RAM (DRAM), static RAM (SRAM), synchronous DRAM (SDRAM), double data rate SDRAM (DDR SDRAM), etc.). Memory 104 can store information related to the image demosaic process, such as raw pixel values, color sample values, intermediate pixel values, output pixel values, transformation matrices, kernel filter values, and the like. In some embodiments, memory 104 can be communicatively coupled to image demosaic circuit 106. In some embodiments, memory 104 can be communicatively coupled to one or more circuits of image demosaic circuit 106.

Image demosaic circuit 106 can include one or more circuits and/or circuit groups for performing image demosaic with minimal artifacts. For example, image demosaic circuit 106 can include raw interpolation circuit 108, chroma estimation circuit 110, luma estimation circuit 112, and color space transformation circuit 114. In some embodiments, image demosaic circuit 106 can include luma zipper filter circuit 116 and/or luma directional enhancement circuit 118. One or more circuits of image demosaic circuit 106 can be communicatively coupled, and the output of one circuit can be provided as an input to another circuit. In some embodiments, a first circuit group can be communicatively coupled to a second circuit group. For example. raw interpolation circuit 108 can receive a color filter array (CFA) (e.g., from memory 104) and can perform interpolation to populate a color value (e.g., green, G) at each position in the CFA. The fully-populated green values of raw interpolation circuit 108 can be provided as part of the input to chroma estimation circuit 110. In some embodiments, the output of a circuit can be stored to memory 104, and another circuit can load the previous output from memory 104 for further processing.

Raw interpolation circuit 108 can perform interpolation on an input CFA to populate one or more color values at each position of the CFA. For example, a CFA with an RGGB Bayer filter pattern can be received as input to raw interpolation circuit 108. In some embodiments, another Bayer filter pattern can be used. The CFA can include one color value (e.g., R, G, or B) at each pixel location. Raw interpolation circuit 108 can interpolate (e.g., via linear interpolation) one of the color values (e.g., G) so that the selected color has a value at each pixel location of the CFA.

In some embodiments, directional interpolation is performed. For example, to determine a direction of a given pixel P, a patch of raw color values from the CFA centered on P can be smoothed using a bilinear low-pass filter (LPF). The absolute value of differences between second order derivatives of the smoothed pixel values can be determined in a horizontal direction and in a vertical direction. The direction with the higher value can be considered the direction of the pixel P. Based on the determined direction of the pixel P, the interpolated color value at that position can be calculated by applying more weight to the neighboring color values along the same direction.

Following the interpolation, raw interpolation circuit 108 can output a modified CFA with each pixel location having a value for a particular color (e.g., G). The modified CFA with fully-populated color values (of at least a single color) can be provided to chroma estimation circuit 110.

Chroma estimation circuit 110 can convert the fully-populated color values from the first color space (e.g., from the RGB color space) into an intermediate color space (e.g., YiUiVi color space). Based on the fully-populated color values computed by raw interpolation circuit 108, a first chroma value in the intermediate color space can be calculated for each pixel location. A different formula can be used for different pixel locations of the CFA based on what color values are available at that location. For example, a first chroma value can be computed for pixels that have a raw R color value using a first formula, while a second chroma value can be computed for pixels that have a raw B color value using a second formula. In some embodiments, both formulas depend on the raw or computed G color value at the same location.

For example, a Ui value can be computed for each pixel location of the CFA that has a B raw color value using the following:

Ui=(B−G)/2.

A Vi value can be computed for each pixel location of the CFA that has an R raw color value using the following:

Vi=(R−G)/2.

Interpolation and/or up-sampling can be used to populate each pixel location of the CFA with a Ui value and a Vi value based on the neighboring computed Ui and Vi values. The Ui and Vi values can be smoothed to obtain Uc and Vc using a LPF.

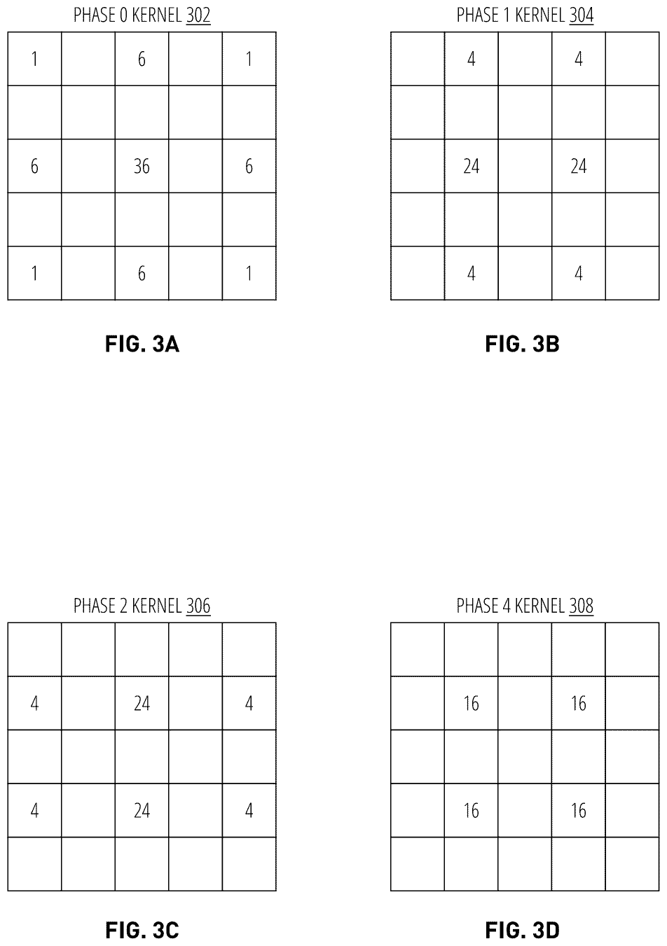

In some embodiments, the Ui and Vi values can be interpolated and smoothed simultaneously using a poly-phase filter. For example, a 4-phase poly-phase filter can be determined based on a LPF kernel. Each phase of the filter can correspond to a different pattern of values surrounding the value to be interpolated and/or smoothed. For example, if the pixel to be interpolated and/or smoothed is at a location with a raw B color value, a first phase of the poly-phase filter can be used to compute the smoothed Uc value at that location. (See FIG. 3A). If the pixel to be interpolated and/or smoothed has raw B color values to the left and right, a second phase of the poly-phase filter can be used to compute the smoothed Uc value at that location. (See FIG. 3B). If the pixel to be interpolated and/or smoothed has raw B color values above and below, a third phase of the poly-phase filter can be used to compute the smoothed Uc value at that location. (See FIG. 3C). If the pixel to be interpolated and/or smoothed has raw B color values at its corners, a fourth phase of the poly-phase filter can be used to compute the smoothed Uc value at that location. (See FIG. 3D). A similar process can be applied for computing the smoothed Vc values.

In some embodiments, trimming some of the values used in the poly-phase filter computation can be valuable. By removing outlier values, small feature colors can be preserved while mitigating chroma artifacts. For example, the values used in the poly-phase filter computation can be sorted in a list by value (e.g., lowest to highest, highest to lowest). The median value at the middle of the list can be determined. One or more values of the list that satisfy an outlier criterion (e.g., the lowest value(s), the highest value(s), values above (or below) a predetermined threshold, etc.) can be changed to the median value. The poly-phase filter computation can then continue using the modified value(s).

In the case where no values are modified, the trimmed poly-phase filter can be equivalent to an up-sampling filter. In the case where all values are modified, the trimmed poly-phase filter can be equivalent to a median filter.

Chroma estimation circuits 110 can output a CFA with fully-populated Ui and Vi (or Uc and Vc) values. The output can be stored in memory 104 or can be provided as input to luma estimation circuit 112.

Luma estimation circuit 112 can compute a luma value Yi within the intermediate color space for each pixel location of the CFA based on the computed chroma values from chroma estimation circuit 110 and based on the raw CFA color values in the first color space. For example, the color sample value of a particular pixel can be combined with the computed Ui value and Vi value for that pixel to obtain the Yi value for the pixel. In some embodiments, different weights are applied to the Ui and Vi values (e.g., chroma correction) based on the color of the pixel in the CFA. For example, the Yi value for a pixel with a raw R color value can be computed using the following:

Yi=R+0.5Ui−1.5Vi.

The Yi value for a pixel with a raw G color value can be computed using the following:

Yi=G+0.5Ui+0.5Vi.

The Yi value for a pixel with a raw B color value can be computed using the following

Yi=B−1.5Ui+0.5Vi.

In some embodiments, the smoothed values (e.g., Uc, Vc) are used instead of the intermediate values (e.g., Ui, Vi) to obtain a luma estimate (e.g., Yc). The computed Yi (or Yc) luma values can be stored in memory 104 and/or can be provided to another circuit of image demosaic circuit 106 (e.g., luma zipper filter circuit 116, luma directional enhancement circuit 118, or color space transformation circuit 114).

In some embodiments, luma zipper filter circuit 116 can be used to apply a luma zipper filter to the intermediate luma values (e.g., Yi values, Yc values) to remove (or reduce) zippering artifacts that would appear in the full-color image. The luma zipper filter can be a bilateral low-pass filter (LPF). In some embodiments, the luma zipper filter is a 2-dimensional filter such that the output is a linear combination of a window of input intermediate luma values weighted by fixed filter kernel coefficients and dynamic range kernel coefficients that depend on the input range and the input intermediate luma values. The fixed filter kernel can have a wide passband to preserve high frequency content (e.g., textures, image details, etc.) in the full-color image. In some embodiments, the improved value of a single intermediate luma value can be computed based on a 9×9 patch of input intermediate luma values.

For example, in some embodiments, the zipper filtered luma value Yd can be computed using the following equation:

$${Y}_{d} = \frac{{\sum }_{i , j = - 4}^{4} ( {Y}_{c} ( i , j ) F ( i , j ) R ( i , j ) )}{{\sum }_{i , j = - 4}^{4} ( F ( i , j ) R ( i , j ) )}$$

where Yc(i,j) can be a patch of (smoothed) luma values (e.g., a 9×9 patch), F(i,j) can be a spatial kernel, and R(i,j) can be a range kernel. In some embodiments, the range kernel can be a function dependent on the luma values Yc and a set of central luma values (e.g., values of Yc(i,j) where −1≤i≤1 and −1≤j≤1). An input range can be computed based on the central luma values. If a particular value Yc(i,j) is within the input range, then R(i,j) can be unity. On the other hand, if Yc(i,j) is way outside the input range (e.g., based on exceeding a predetermined threshold, etc.), R(i,j) can be zero. The values in between can be tapered.

The computed Yd luma values can be stored in memory 104 and/or can be provided to another circuit of image demosaic circuit 106 (e.g., luma directional enhancement circuit 118 or color space transformation circuit 114).

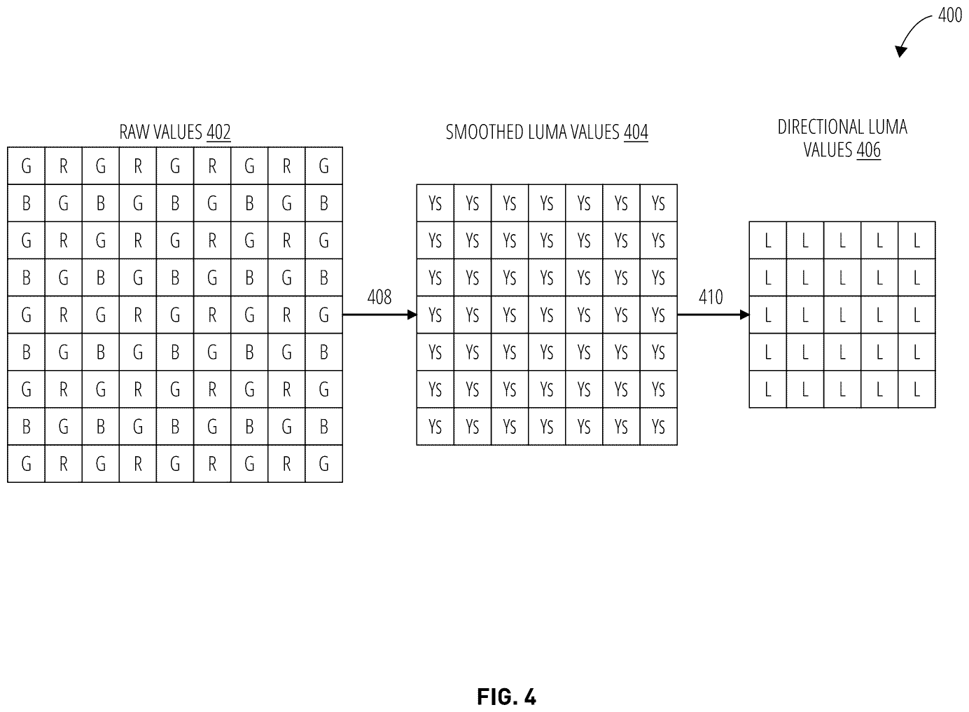

In some embodiments, luma directional enhancement circuit 118 can apply a directional filter to the intermediate luma values (e.g., Yi values, Yc values, Yd values) to smooth edges in the final full-color image. The directional filter can start with a 9×9 patch of raw values (e.g., from the CFA) and apply a bilinear LPF to compute a 7×7 patch of smoothed luma values. Edge directions can be computed within a 5×5 patch of the smoothed luma values by taking the absolute value of differences between second order derivatives of the smoothed luma values in a horizontal direction and in a vertical direction. (See FIG. 4). For example, the horizontal edge value can be computed using the following:

Gh(i,j)=|Ys(i−1,j)−2*Ys(i,j)+Ys(i+1,j).

The vertical edge value can be computed using the following:

Gv(i.j)=|Ys(i,j−1)−2*Ys(i,j)+Ys(i,j+1).

The local direction of a particular pixel can be horizontal (with a value of 1) if Gh(i,j)<Gv(i.j) or vertical (with a value of −1) otherwise.

A strength of the edge S(M) can be determined by applying a normalized LPF kernel to the computed directions (e.g., L(i,j) values) and summing the values. A large positive value can indicate a strong horizontal edge, and a large negative value can indicate a strong vertical edge. The luma value for the pixel (e.g., Yd) can then be modified based on the determined direction. For example, a horizontal adjustment value can be computed with the following

Yhor=(Yc(−1,0)+2*Yc(0,0)+Yc(1,0))/4.

A vertical adjustment value can be computed with the following:

Yver=(Yc(0,−1)+2*Yc(0,0)+Yc(0,1))/4.

The luma value Yd can be modified (e.g., combined with, added to, subtracted from, etc.) by (Yhor−Yd)*S(M) (or (Yver−Yd)*S(M) for vertical edges) to obtain Yc.

The computed Ye luma values can be stored in memory 104 and/or can be provided to another circuit of image demosaic circuit 106 (e.g., color space transformation circuit 114).

Color space transformation circuit 114 can convert the resulting intermediate values (e.g., YiUiVi, YcUc Vc, YdUcVc, YeUcVc) to the output color space (e.g., YUV) using one or more transformation operations. For example, the intermediate values can be multiplied by one or more transformation matrices to obtain the output values. The output of color space transformation circuit 114 can be a full-color image of the original raw CFA and can contain minimal demosaic artifacts.

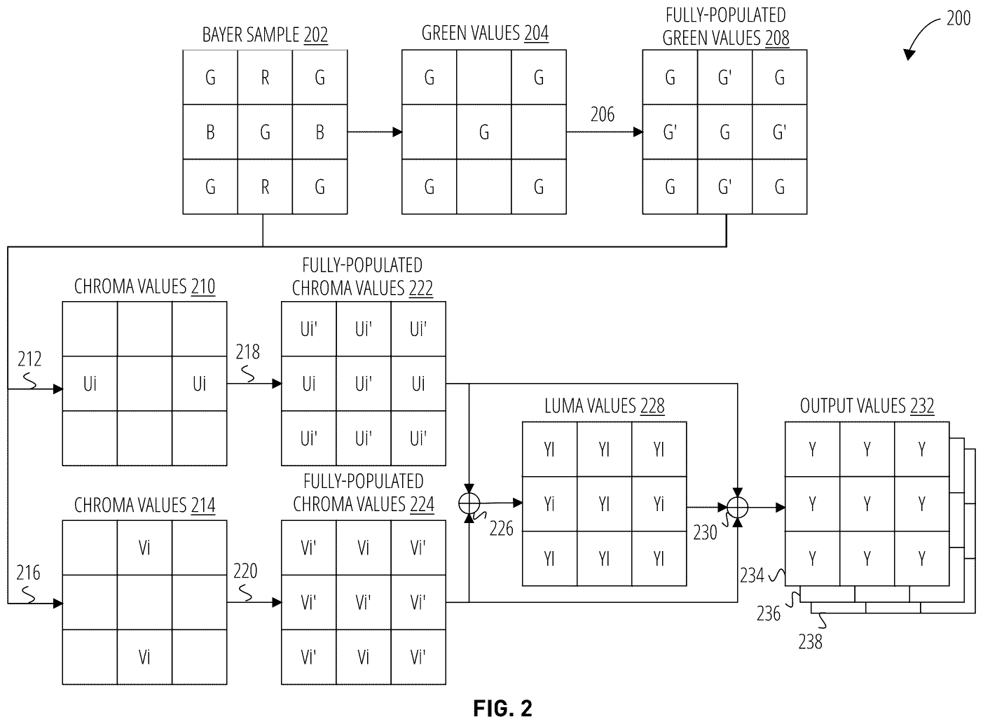

FIG. 2 is a block diagram of an example data flow 200 for demosaicing color samples to obtain a full-color output, according to at least one embodiment. In some embodiments, data flow 200 depicts the image demosaic process described above in relation to FIG. 1. Bayer sample 202 can include one or more pixel, each having at least one color value within a first color space (e.g., the RGB color space). The color values of a single color (e.g., green values 204) can be interpolated using directional interpolation 206 to so each pixel has a corresponding value of that color (e.g., fully-populated green values 208).

Chroma estimation 212 can combine Bayer sample 202 and fully-populated green values 208 to obtain chroma values 210. For example, Ui can be computed at pixels with raw B color values using the formula

Ui=(B−G)/2(or Ui=(B−Gi)/2).

Then chroma interpolation 218 can be performed to populate Ui at all pixel locations (e.g., to obtain fully-populated chroma values 222). Chroma interpolation 218 can use a poly-phase filter to interpolate and/or up-sample the Ui values to all pixel locations. In some embodiments, a trimmed poly-phase filter is used. The poly-phase filter can smooth the Ui values to obtain Uc values.

Similarly, chroma estimation 216 can combine Bayer sample 202 and fully-populated green values 208 to obtain chroma values 214. For example, Vi can be computed at pixels with raw R color values using the formula

Vi=(R−G)/2(or Vi=(R−Gi)/2).

Then chroma interpolation 220 can be performed to populate Vi at all pixel locations (e.g., to obtain fully-populated chroma values 224). Chroma interpolation 220 can use a poly-phase filter to interpolate and/or up-sample the Vi values to all pixel locations. In some embodiments, a trimmed poly-phase filter is used. The poly-phase filter can smooth the Vi values to obtain Vc values.

Luma estimation 226 can receive fully-populated chroma values 222 and fully-populated chroma values 224 to compute luma values 228. Luma estimation 226 can also receive Bayer sample 202. Luma estimation 226 can compute luma values 228 using the following formulas. For pixels with raw R color values: Yi=R+0.5Ui−1.5Vi. For pixels with raw G color values: Yi=G+0.5Ui+0.5Vi. For pixels with raw B color values: Yi=B−1.5Ui+0.5Vi. In some embodiments, the smoothed values (e.g., Uc, Vc) are used instead of the intermediate values (e.g., Ui, Vi) to obtain a luma estimate (e.g., Yc).

Color space transformation 230 can combine luma values 228, fully-populated chroma values 222, and fully-populated chroma values 224 to generate output values 232. Output values 232 can represent the output full-color image. Output values 232 can include values for the luma component 234 of the output color space, values for a first chroma component 236 of the output color space, and values for a second chroma component 238 of the output color space. In some embodiments, color space transformation 230 transforms luma values 228, fully-populated chroma values 222, and fully-populated chroma values 224 using one or more transformation matrices.

FIG. 3A is a block diagram of an example kernel (phase 0 kernel 302) of a poly-phase filter, according to at least one embodiment. Phase 0 kernel 302 can be based on a 5×5 LPF kernel. Although phase 0 kernel 302 is not normalized in FIG. 3A, in some embodiments, a normalized LPF kernel can be used instead. Phase 0 kernel 302 can be used during chroma estimation to interpolate and/or up-scale and/or smooth Ui/Vi values to neighboring pixel positions when the color value being interpolated (e.g., B for Ui, R for Vi) is at the center of the kernel.

FIG. 3B is a block diagram of an example kernel (phase 1 kernel 304) of a poly-phase filter, according to at least one embodiment. Phase 1 kernel 304 can be based on a 5×5 LPF kernel. Although phase 1 kernel 304 is not normalized in FIG. 3B, in some embodiments, a normalized LPF kernel can be used instead. Phase 1 kernel 304 can be used during chroma estimation to interpolate and/or up-scale and/or smooth Ui/Vi values to neighboring pixel positions when the color value being interpolated (e.g., B for Ui, R for Vi) is on the left and right of the pixel being interpolated.

FIG. 3C is a block diagram of an example kernel (phase 2 kernel 306) of a poly-phase filter, according to at least one embodiment. Phase 2 kernel 306 can be based on a 5×5 LPF kernel. Although phase 2 kernel 306 is not normalized in FIG. 3C, in some embodiments, a normalized LPF kernel can be used instead. Phase 2 kernel 306 can be used during chroma estimation to interpolate and/or up-scale and/or smooth Ui/Vi values to neighboring pixel positions when the color value being interpolated (e.g., B for Ui, R for Vi) is on the top and bottom of the pixel being interpolated.

FIG. 3D is a block diagram of an example kernel (phase 4 kernel 308) of a poly-phase filter, according to at least one embodiment. Phase 4 kernel 308 can be based on a 5×5 LPF kernel. Although phase 4 kernel 308 is not normalized in FIG. 3D, in some embodiments, a normalized LPF kernel can be used instead. Phase 4 kernel 308 can be used during chroma estimation to interpolate and/or up-scale and/or smooth Ui/Vi values to neighboring pixel positions when the color value being interpolated (e.g., B for Ui, R for Vi) is on the corners of the pixel being interpolated.

FIG. 4 is a block diagram of an example data flow 400 for luma directional enhancement, according to at least one embodiment. As described above, luma values (e.g., Yi values, Yc values, Yd values) can be directionally enhanced to reduce artifacts (e.g., to smooth edges) in the output full-color image. The directional filter can start with a 9×9 patch of raw values 402 (e.g., from the CFA). Bilinear LPF 408 can be applied to raw values 402 to obtain a 7×7 patch of smoothed luma values 404. Then, direction detection 410 can be performed to compute edge directions within smoothed luma values 404 to obtain directional luma values 406. Each local direction L can be based on the absolute value of differences between second order derivatives of the smoothed luma values in a horizontal direction and in a vertical direction. For example, the horizontal edge value can be computed using the following:

Gh(i,j)=|Ys(i−1,j)−2*Ys(i,j)+Ys(i+1,j).

The vertical edge value can be computed using the following:

Gv(i.j)=|Ys(i,j−1)−2*Ys(i,j)+Ys(i,j+1).

The local direction L of a particular pixel can be horizontal (with a value of 1) if Gh(i,j)<Gv(i.j) or vertical (with a value of −1) otherwise.

In some embodiments, direction detection can be performed during one or more of the above described processes (e.g., during chroma estimation, during luma estimation, during luma directional enhancement, etc.).

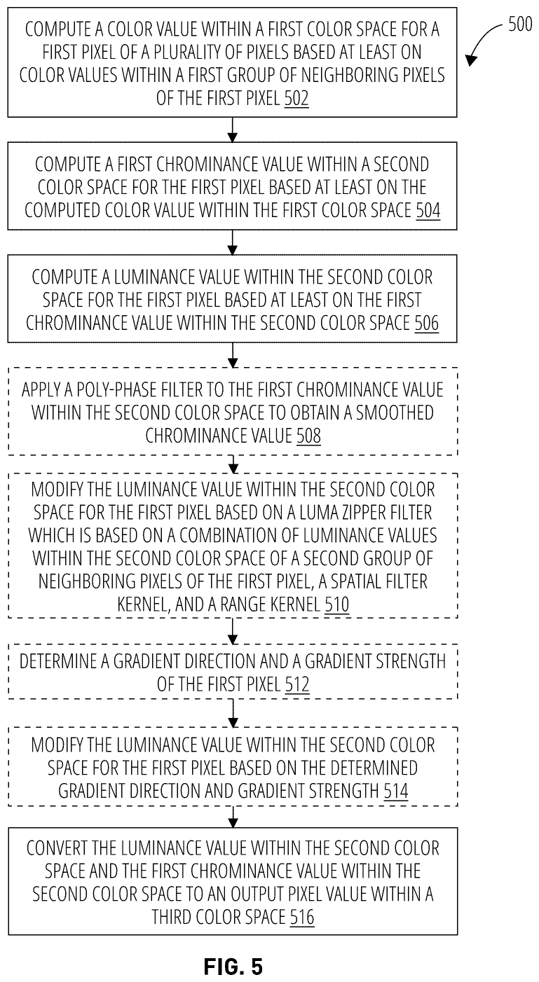

FIG. 5 is a flow diagram of an example method 500 for image demosaicing with minimal artifacts, according to at least one embodiment. Method 500 can be performed using one or more processing units (e.g., central processing units (CPUs), graphics processing units (GPUs), accelerators, physics processing units (PPUs), data processing units (DPUs), etc.), which may include (or communicate with) one or more memory devices. In at least one embodiment, method 500 can be performed using a processing device or processing devices. In at least one embodiment, method 500 can be performed using one or more processing units of computer system 600. In at least one embodiment, method 500 can be performed by image demosaic system 102 of FIG. 1. In at least one embodiment, processing units performing method 500 can be executing instructions stored on a non-transient computer readable storage media. In at least one embodiment, method 500 can be performed using multiple processing threads (e.g., CPU threads and/or GPU threads), individual threads executing one or more individual functions, routines, subroutines, or operations of the method. In at least one embodiment, processing threads implementing method 500 can be synchronized (e.g., using semaphores, critical sections, and/or other thread synchronization mechanisms). Alternatively, processing threads implementing method 500 can be executed asynchronously with respect to each other. Various operations of method 500 can be performed in a different order compared with the order shown in FIG. 5. Some operations of method 500 can be performed concurrently with other operations. In at least one embodiment, one or more operations shown in FIG. 5 may not always be performed.

Referring to FIG. 5, at block 502, processing units executing method 500 can compute a color value within a first color space for a first pixel of a plurality of pixels based at least on color values within a first group of neighboring pixels of the first pixel. In some embodiments, the pixels of the first group of neighboring pixels are part of the plurality of pixels. In some embodiments, processing units can determine a gradient direction of the first pixel and compute the color value within the first color space for the first pixel of the plurality of pixels based at least on the color values within the first color space of the first group of neighboring pixels along the gradient direction of the first pixel.

At block 504, processing units can compute a first chrominance value within a second color space for the first pixel based at least on the computed color value within the first color space. At block 506, processing units can compute a luminance value within the second color space for the first pixel based at least on the first chrominance value within the second color space.

In some embodiments, at block 508, processing units can apply a poly-phase filter to the first chrominance value within the second color space to obtain a smoothed chrominance value. In some embodiments, at least one value of the poly-phase filter is modified based on satisfaction of an outlier criterion. For example, a particular phase of the poly-phase filter may be selected and may consider N chrominance values around the chrominance value to be smoothed. The N values can be sorted according to their value (e.g., according to their magnitude) and one or more values of the N values that satisfy an outlier criterion (e.g., the highest value(s), the lowest value(s), etc.) can be modified. In some embodiments, one or more outlier values can be set to the median value of the N values.

In some embodiments, at block 510, processing units executing method 500 can modify the luminance value within the second color space for the first pixel based on a luma zipper filter which is based on a combination of luminance values within the second color space of a second group of neighboring pixels of the first pixel, a spatial filter kernel, and a range kernel.

In some embodiments, at block 512, processing units can determine a gradient direction and a gradient strength of the first pixel. At block 514, processing units can modify the luminance value within the second color space for the first pixel based on the determined gradient direction and gradient strength.

At block 516, processing units executing method 500 can convert the luminance value within the second color space and the first chrominance value within the second color space to an output pixel value within a third color space. To convert the luminance value within the second color space and the first chrominance value within the second color space to an output pixel value within a third color space, processing units can apply a transformation matrix to the luminance value within the second color space and the first chrominance value within the second color space.

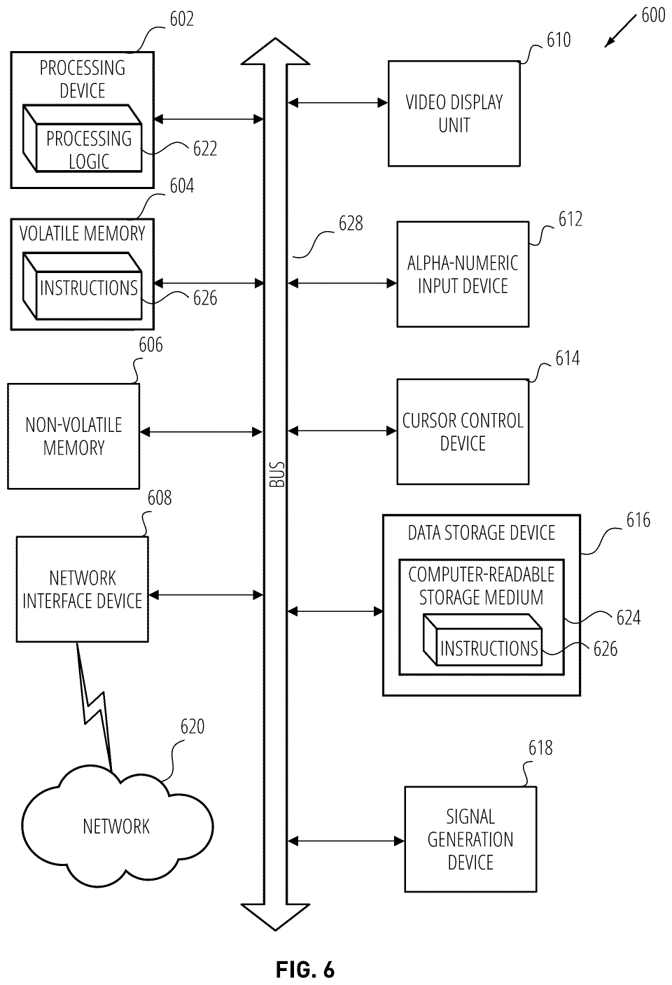

FIG. 6 is a block diagram illustrating an exemplary computer system, in accordance with at least one embodiment of the present disclosure. The computer system 600 include image demosaic system 102 of FIG. 1. Computer system 600 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed here in.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 616, which communicate with each other via a bus 628.

Processor (processing device) 602 represents one or more general-purpose processing devices such as a microprocessor, central processing unit, or the like, and may include processing logic 622. More particularly, the processor 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 can also be one or more special-purpose processing devices such as an application specific integrated circuit (ASIC), a field programmable gate array (FPGA), a digital signal processor (DSP), network processor, or the like. The processor 602 is configured to execute instructions 626 (e.g., for generating threat indicator alerts) for performing the operations discussed herein.

The computer system 600 can further include a network interface device 608. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 618 (e.g., a speaker). In some embodiments, computer system 600 may not include video display unit 610, input device 612, and/or cursor control device 614 (e.g., in a headless configuration).

The data storage device 616 can include a non-transitory machine-readable storage medium 624 (also computer-readable storage medium) on which is stored one or more sets of instructions 626 (e.g., for demosaicing color samples into full-color images) embodying any one or more of the methodologies or functions described herein. The instructions 626 can also reside, completely or at least partially, within the main memory 604 and/or within the processor 602 during execution thereof by the computer system 600, the main memory 604 and the processor 602 also constituting machine-readable storage media. The instructions can further be transmitted or received over a network 620 via the network interface device 608.

In one implementation, the instructions 626 include instructions for demosaicing color samples into full-color images. While the computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A circuit comprising:
a first circuit to:
compute a color value within a first color space for a first pixel of a plurality of pixels based at least on color values within the first color space of a first group of neighboring pixels of the first pixel, wherein the pixels of the first group of neighboring pixels are part of the plurality of pixels; and
provide the color value within the first color space to a second circuit; the second circuit communicatively coupled to the first circuit, the second circuit to:
compute a first chrominance value within a second color space for the first pixel based at least on the computed color value within the first color space; and
provide the first chrominance value within the second color space to a third circuit;
the third circuit communicatively coupled to the second circuit, the third circuit to:
compute a luminance value within the second color space for the first pixel based at least on the first chrominance value within the second color space; and
provide the luminance value within the second color space to a fourth circuit; and
the fourth circuit communicatively coupled to the third circuit, the fourth circuit to:
convert the luminance value within the second color space and the first chrominance value within the second color space to an output pixel value within a third color space.

2. The circuit of claim 1, wherein to compute the color value within the first color space for the first pixel of the plurality of pixels based at least on the color values within the first color space of the first group of neighboring pixels of the first pixel, the first circuit is to:
determine a gradient direction of the first pixel; and
compute the color value within the first color space for the first pixel of the plurality of pixels based at least on the color values within the first color space of the first group of neighboring pixels along the gradient direction of the first pixel.

3. The circuit of claim 1, the third circuit further to apply a poly-phase filter to the first chrominance value within the second color space to obtain a smoothed chrominance value.

4. The circuit of claim 3, wherein at least one value of the poly-phase filter is modified based on satisfaction of an outlier criterion.

5. The circuit of claim 1, the third circuit further to modify the luminance value within the second color space for the first pixel based on a luma zipper filter which is based on a combination of luminance values within the second color space of a second group of neighboring pixels of the first pixel, a spatial filter kernel, and a range kernel.

6. The circuit of claim 1, the third circuit further to:
determine a gradient direction and a gradient strength of the first pixel; and
modify the luminance value within the second color space for the first pixel based on the determined gradient direction and gradient strength.

7. The circuit of claim 1, wherein to convert the luminance value within the second color space and the first chrominance value within the second color space to an output pixel value within the third color space, the fourth circuit is to apply a transformation matrix to the luminance value within the second color space and the first chrominance value within the second color space.

8. A system comprising:
a memory device; and
one or more circuit groups communicatively coupled to the memory device, the one or more circuit groups to:
compute a color value within a first color space for a first pixel of a plurality of pixels based at least on color values within the first color space of a first group of neighboring pixels of the first pixel, wherein the pixels of the first group of neighboring pixels are part of the plurality of pixels;
compute a first chrominance value within a second color space for the first pixel based at least on the computed color value within the first color space;
compute a luminance value within the second color space for the first pixel based at least on the first chrominance value within the second color space; and
convert the luminance value within the second color space and the first chrominance value within the second color space to an output pixel value within a third color space.

9. The system of claim 8, wherein to compute the color value within the first color space for the first pixel of the plurality of pixels based at least on the color values within the first color space of the group of neighboring pixels of the first pixel, the one or more circuit groups are to:
determine a gradient direction of the first pixel; and
compute the color value within the first color space for the first pixel of the plurality of pixels based at least on the color values within the first color space of the first group of neighboring pixels along the gradient direction of the first pixel.

10. The system of claim 8, the one or more circuit groups further to apply a poly-phase filter to the first chrominance value within the second color space to obtain a smoothed chrominance value.

11. The system of claim 10, wherein at least one value of the poly-phase filter is modified based on satisfaction of an outlier criterion.

12. The system of claim 8, the one or more circuit groups further to modify the luminance value within the second color space for the first pixel based on a luma zipper filter which is based on a combination of luminance values within the second color space of a second group of neighboring pixels of the first pixel, a spatial filter kernel, and a range kernel.

13. The system of claim 8, the one or more circuit groups further to:
determine a gradient direction and a gradient strength of the first pixel; and
modify the luminance value within the second color space for the first pixel based on the determined gradient direction and gradient strength.

14. The system of claim 8, wherein to convert the luminance value within the second color space and the first chrominance value within the second color space to an output pixel value within the third color space, the one or more circuit groups are to apply a transformation matrix to the luminance value within the second color space and the first chrominance value within the second color space.

15. A system comprising:
a memory device; and
one or more circuit groups communicatively coupled to the memory device, the one or more circuit groups comprising:
a first circuit group to:
compute a color value within a first color space for a first pixel of a plurality of pixels based at least on color values within the first color space of a first group of neighboring pixels of the first pixel, wherein the pixels of the first group of neighboring pixels are part of the plurality of pixels; and
provide the color value within the first color space to a second circuit group; and
the second circuit group communicatively coupled to the first circuit group, the second circuit group to:
compute a first chrominance value within a second color space for the first pixel based at least on the computed color value within the first color space of the first circuit group;
compute a luminance value within the second color space for the first pixel based at least on the first chrominance value within the second color space; and
convert the luminance value within the second color space and the first chrominance value within the second color space to an output pixel value within a third color space.

16. The system of claim 15, wherein to compute the color value within the first color space for the first pixel of the plurality of pixels based at least on the color values within the first color space of the first group of neighboring pixels of the first pixel, the first circuit group is to:
determine a gradient direction of the first pixel; and
compute the color value within the first color space for the first pixel of the plurality of pixels based at least on the color values within the first color space of the first group of neighboring pixels along the gradient direction of the first pixel.

17. The system of claim 15, the second circuit group further to apply a poly-phase filter to the first chrominance value within the second color space to obtain a smoothed chrominance value.

18. The system of claim 17, wherein at least one value of the poly-phase filter is modified based on satisfaction of an outlier criterion.

19. The system of claim 15, the second circuit group further to modify the luminance value within the second color space for the first pixel based on a luma zipper filter which is based on a combination of luminance values within the second color space of a second group of neighboring pixels of the first pixel, a spatial filter kernel, and a range kernel.

20. The system of claim 15, the second circuit group further to:
determine a gradient direction and a gradient strength of the first pixel; and
modify the luminance value within the second color space for the first pixel based on the determined gradient direction and gradient strength.
